(19) United States
(12) Patent Application Publication
(10) Pub. No.: US 2025/0219845 A1
(43) Pub. Date: Jul. 3, 2025

(54) PROVABLE REMOTE EXECUTION OF A COMPUTER PROGRAM

(71) Applicant: FLUGDACHS INTELLECTUAL PROPERTY GMBH, Graz (AT)

(72) Inventor: Michael SEIDL, Graz (AT)

(21) Appl. No.: 18/717,810

(22) PCT Filed: Dec. 7, 2021
(86) PCT No.: PCT/AT2021/060464

§ 371 Date: Jun. 7, 2024

(51) Int. Cl. H04L 9/32; H04L 9/08; H04L 9/40

(52) U.S. Cl. CPC H04L 9/3247; H04L 9/0825; H04L 9/0869; H04L 9/3236; H04L 9/40

(57) ABSTRACT

Method, network client and system for provable remote execution of a computer program (17) by a network client (15) having a client private key (25), the method comprising the steps of:
receiving by the network client (15) a copy of the computer program (17),
executing by the network client (15) the computer program (17),
generating by the network client (15) a digital signature (24) of at least a final state (3) of the computer program (17) with the client private key (24),
transmitting by the network client (15) the digital signature (24) of the final state (3) for validation of the execution of the computer program (17).

The invention concerns a method for provable remote execution of a computer program as well as a network client configured to perform the method.

EP 1 016 049 B1 shows an apparatus and a method for verifying honest gaming transactions over a communications network, and particularly for verifying gambling transactions over the Internet. The random sequence created during a game and decisive for the outcome of the game for each player can be reconstructed using the deterministic randomization process based on a cooperative seed generation process. The purpose of this method is that players as well as regulators are able to reassemble any game to prove that the host (typically a casino) and all players played the game honestly. The method is limited to a provable application of game rules that are known to all participants beforehand. This publication does not disclose or even hint at the possibility of provable remote execution of a general computer program.

It is an object of the invention to provide an auditable and potentially validated result of the execution of a given computer program at a client computer with minimal latency due to network communication not required by the computer program itself and with minimal computing effort for other computers during runtime.

To solve this object, the invention proposes a method according to claim 1 and a network client according to claim 13.

The disclosed method proposes provable remote execution of a computer program by a network client having a client private key, the method comprising the steps of:
receiving by the network client a copy of the computer program,
executing by the network client the computer program,
generating by the network client a digital signature of at least a final state of the computer program with the client private key,
transmitting by the network client the digital signature of the final state for validation of the execution of the computer program.

The digital signature may be based on the final state and the computer program itself. The final state may for example be the aggregation of the results output by the computer program. For example, it may comprise a memory snapshot of the finished computer program, e.g. including its head and/or stack and any other memory areas accessed or written by the computer program. At a higher level, the state may be defined as a collection of all variables allocated at the end of the computer program. Or it may be limited by definition to the content of a particular state variable or of a particular state memory area or of particular state registers. Typically, it will be useful to include at least those results of the remote execution in the final state that have been the purpose for which the computer program has been designed and executed. The digital signature may for example be an encrypted version of a hash value over at least the final state and the computer program (wherein the final state and/or the computer program may in general be replaced by their respective hash values that are at least as long as the new hash value), using the client private key as the encryption key for either asymmetric or symmetric encryption. According to another example, the digital signature may be a keyed-hash message authentication code (HMAC) using the client private key as secret key and at least the final state and the computer program as the message to be authenticated. Generally, the digital signature and the client private key can be used in any way that allows secure attribution of the signed final state hash to the network client. This attribution enables a transfer of value in exchange for the remote execution performed by the network client and thus an incentive for the network client to participate in the remote execution. The present disclosure therefore also provides a secure incentivising scheme for delegating computing work as distributed computing closer to remote data sources at the “edge” of a network (“edge computing”), e.g. the Internet.

In order to make the digital signature verifiable and thus the remote execution provable, any association between the final state and the computer program is sufficient. The final state may be only implicitly bound to a particular computer program (for example, a program identifier and revision may be part of the final state or different program identifiers and revisions may otherwise indirectly affect the final state such that they result in different and discernible final states). In general, it is sufficient that the computer program subject of the remote execution can be identified for potential later validation of the execution. For that purpose, any identifier can be used, such as a name and revision of the program or a resource locator (e.g. URL) for accessing a copy of the computer program. The computer program may for example be provided in a decentralised manner, e.g. via the InterPlanetary File System (IPFS). The use of a hash value of the computer program as the identifier, for example, has the additional advantage, that the integrity of the computer program can be checked before execution by the network client as well as before any potential validation of the execution. However, in any of those situations it is not necessary that the information identifying the computer program as such being signed with the digital signature as long as the digitally signed final state is at least implicitly bound to the identified computer program as mentioned above.

Optionally, executing the computer program may comprise the step of determining by the network client a state hash of at least one intermediary state of the computer program, wherein the digital signature generated by the network client is based on the final state and at least one state hash of an intermediary state. In this way, the digital signature not only confirms the final state as such, but a sequence of at least one intermediary state before the final state. The sequence incorporates the concept of time and run-time into the provable result of the remote execution. The hash function(s) used for generating the state hash and as part of the digital signature introduce entropy, more specifically information entropy, into the method and thus enforce a particular direction of the sequence (an “arrow of time”), providing security against attempts to forge an execution result based on a guess or approximation thereof.

The intermediary states may be defined by the computer program itself (cooperative state triggers) or by general constraints of the executing system, such as a predefined number of executed commands since the last intermediary state (pre-emptive state triggers). The state hash at those intermediary states may be determined in a similar fashion as the digital signature of the final state. The different definitions of “state” described above in detail apply not only to the final state, but may also apply to any intermediary state.

In one embodiment, the disclosed method comprises determining by the network client state hashes of the at least two sequential intermediary states of the computer program, wherein the second state hash and every later state hash is computed from at least the corresponding intermediary state and the previous state hash. In this way, a sequence of multiple intermediary states is defined and indirectly attested by the digital signature of the final state. The sequence is ensured essentially by a hash-linked list roughly similar to the basic data structure used in blockchains. Especially for computer programs having a relatively small (or low entropy) state and having potentially multiple ways to reach a given state, the use of those intermediary state hashes ensures that the network client can not take any shortcuts.

In this context, the disclosed method may comprise: receiving by the network client a genesis hash (wherein the “genesis hash” need not be an actual hash value and may be any value that can be used to initialize or “seed” the hash chain, preferably a value of the same memory size as the subsequent state hashes, for example a random value), and determining by the network client the first state hash from at least the corresponding intermediary state and the received genesis hash. The use of an externally provided genesis hash introduces the possibility to perform two or more parallel remote executions of the same computer program and with a different genesis hash to compare the results while the final states are not interchangeable and thus each parallel remote execution is guaranteed to run fully and independently. It should be noted that the results may be comparable only to the extent that they are independent from the genesis hash, which may be not strictly true but only statistically if the genesis hash is used as genesis seed of a deterministic random number generator affecting the execution and thus the final state (see below). Alternatively, the genesis hash may also be derived from a hash of the computer program combined with an identifier or identity of the network client.

In a further embodiment of the disclosed method, the copy of the computer program received by the network client may be digitally signed and the method may comprise the steps of: before executing the computer program, verifying by the network client that the digital signature of the computer program is by a trusted authority. In other words, the copy of the computer program received by the network client may be digitally signed and the network client may require a valid digital signature of the copy in order to authenticate the computer program before spending resources on its execution. This may be particularly useful if the remote execution is carried out in exchange for some type of value or payment, in which case the network client will have an interest to perform only executions cryptographically associated with a trusted authority guaranteeing the validity of the exchange or cryptographically associated with a binding transaction (e.g. a smart contract releasing a defined payment upon provable remote execution of a computer program referenced in the smart contract by its digital signature).

This disclosure has particularly promising applications in the remote execution of computer programs processing local inputs. Specifically, the computer program of the disclosed method may be configured to receive input data locally available at the network client during executing the computer program, wherein the network client records the input data received and provides the recorded input data together with the final state. Such locally available input data may for example include user inputs, such as user reactions or commands, as well as measurements or readings of local sensors, instruments or other interfaces. The processing of such inputs within the framework of the present disclosure enables efficient and virtually latency-free (or even soft or hard real-time) processing of such inputs while at the same time providing provable execution, wherein the outcome or result of the execution can be audited and validated asynchronously or after the fact.

In situations where the final state is associated with a value (e.g. a winning game score) and depends on a particular user input, it may be desirable to limit the possibilities of over-execution, that is, forking of the program execution in search of the user input achieving the highest value final state. Such limitation may be achieved in that the network client receives input data affecting the final state from a network during executing the computer program. This type of input data, not being local, cannot be foreseen by the network client, thus forcing it to collapse the tree of forked states to one particular branch prior to reaching the final state. The network input data (or non-local input data) may for example be implemented by regular update handshakes based on random information (“state checks”), but anything changing the final state meets the purpose. The non-local input data may be received from a remote server or a network of servers, in any event from at least one remote network host different from the network client. In this way it can be foreseen, that the state checks are generated by a system under the control of a different party than the network client, e.g. a trusted authority or a public consensus network.

More specifically, the network client may for example expect to receive input data affecting the final state from the network at one or more instances during executing the computer program, wherein said one or more instances are predefined or defined by the computer program. The validation of the execution can then reconstruct the same expectation and check whether this expectation has been met. In this way, it can be detected during validation if a fraudulent network client ignores or skips the state checks. In practice, the network client may stop executing the computer program if at least one expected input is missing. In such a case, no valid final state can be reached any more, regardless of the reasons that led to the expected input being missed. The act of “receiving” in this context is not limited to either the client sending a request before receiving the input data (the client polls for the input data) or the client receiving the input data without such prior request (the input data is pushed to the client). The digitally signed final state in this embodiment includes the proof that all state checks have been taken into account during execution of the computer program according to the well-defined expectation.

In this context, the expected input data may be unpredictable during each execution of the computer program. For example, the expected input data may contain a random number or specifically a stochastic random number. Alternatively or additionally, the expected input data may include entropy from a source outside the control of the network client, such as a public consensus network or a trusted oracle reporting a sensor reading influenced by a stochastic physical process.

In general, the computer program may use randomly generated data, wherein the randomly generated data is generated locally by the network client. More specifically, in this particular context “randomly generated” refers to generation with a deterministic random generator. If the generated data influences the final state, the process of random generation is such that it can be reproduced for the purpose of validation. That is, during validation, the validating execution of the computer program can generate the same random data.

In one embodiment concerning a computer program using randomly generated data, the disclosed method may comprise the steps of: receiving by the network client a genesis seed; and generating by the network client the randomly generated data based on the received genesis seed. The genesis seed together with the deterministic generation function determines, which random data is generated during the execution of the computer program. Different genesis seeds will result in different random data, while identical genesis seeds will result in the same random data being generated. Thus, by using an unpredictable genesis seed, the generated random data is also unpredictable, at least in its entirety or initially, before the first random data is generated. The genesis seed may be provided by a trusted authority, which may be a service provided by one or more trusted providers or it may be a consensus network of an arbitrary number of trusted or untrusted providers, as discussed below in more detail. The genesis seed may optionally be identical to the genesis hash mentioned above in connection with the generation of state hashes.

Specifically, if the genesis seed is provided by one or more trusted providers, in one particular embodiment the disclosed method may comprise: generating by a network server a genesis seed based on the computer program, a current time stamp and/or a server private key; and transmitting the generated genesis seed from the network server to the network client. In this case, the genesis seed may be linked to the computer program (i.e. one particular instance, version or revision thereof), to a particular time stamp when the remote execution is started, and/or to a particular trusted provider securely identified by a cryptographic key.

Alternatively, as mentioned above, the network client may derive a genesis seed and/or a genesis hash from a publicly accessible state, for example from data confirmed with a secure consensus protocol, such as one or more data elements integrated into a public ledger, distributed or not, (e.g. implemented by a block chain), for example a wallet address, a contract address, a token ID, or a transaction ID.

The scope of the present disclosure extends to a network client configured to perform the method steps attributed to the network client in the method described above and a system configured to perform the method steps of the network client and the network server in the method described above.

Referring now to the drawings, wherein the figures are for purposes of illustrating the present invention and not for purposes of limiting the same:

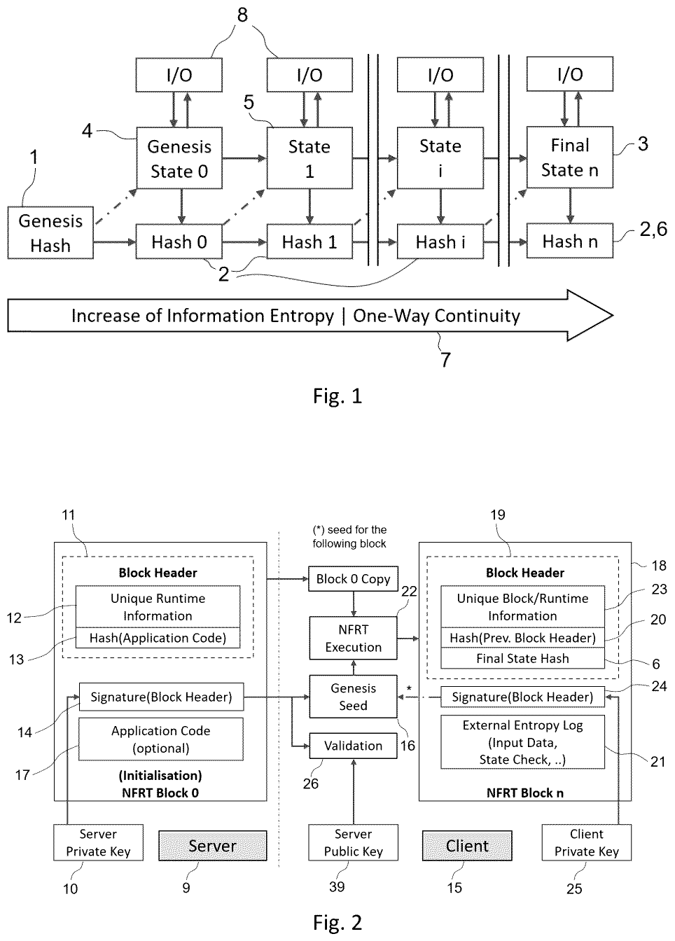

FIG. 1 schematically shows an exemplary information flow scheme that illustrates the different states during a provable remote execution of a computer program by a network client in chronological sequence;

FIG. 2 schematically illustrates the content of two blocks on a block chain used for initialising and proving the remote execution of the computer program;

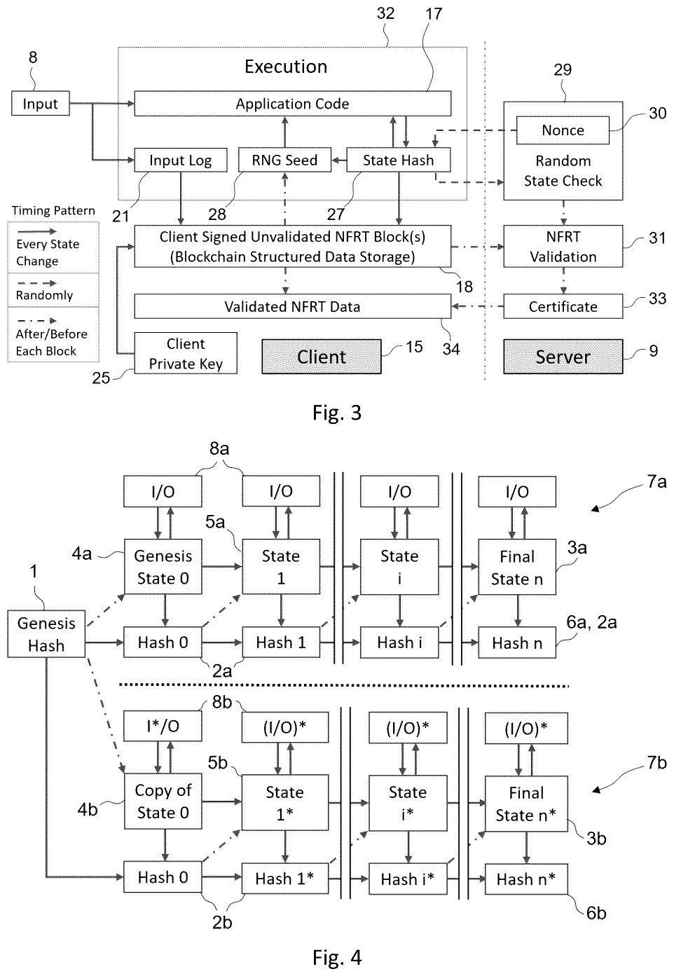

FIG. 3 schematically shows a data flow scheme of a provable remote execution that illustrates how different data sources and parameters influence the result;

FIG. 4 schematically illustrates two parallel remote executions creating two independent sequences of states according to FIG. 1;

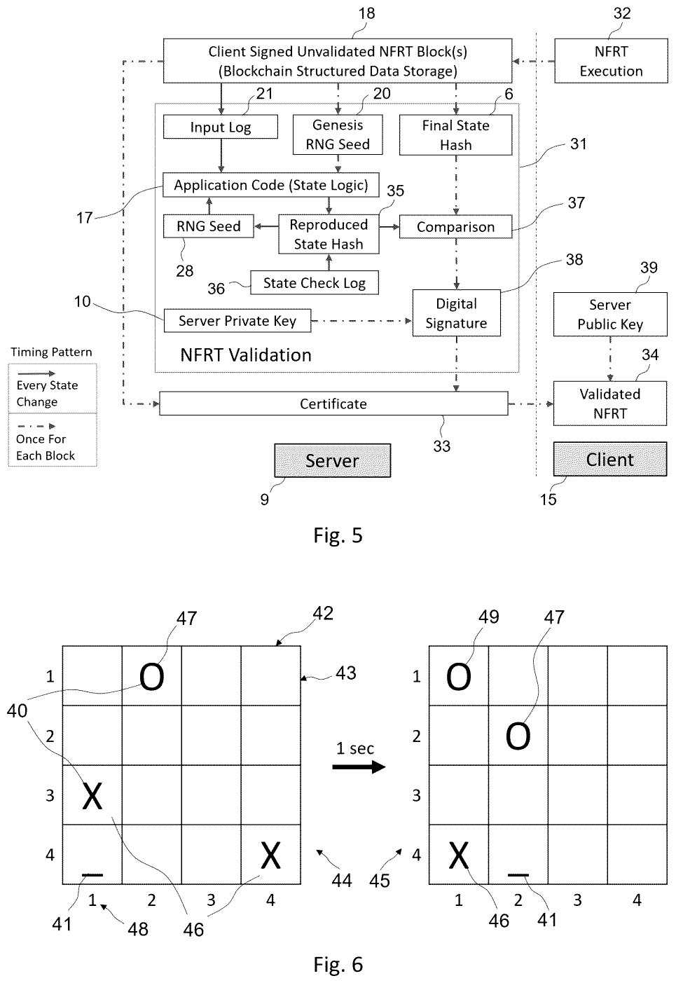

FIG. 5 schematically shows a data flow scheme of the validation of a provable remote execution according to FIG. 3;

FIG. 6 shows a transition between two states of a game used as an exemplary application of a provable remote execution; and

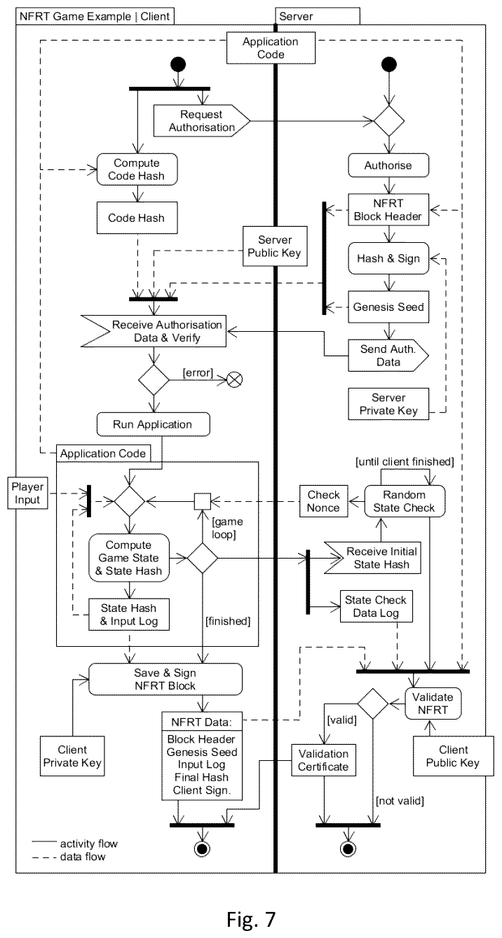

FIG. 7 shows a simplified activity diagram according to the Unified Modeling Language standard.

In one embodiment, the provable remote execution may be provided as a cryptographic protocol defining a method that allows for non-fungible software runtime (NFRT) execution. A network client performing such a NFRT execution receives a copy of the computer program (or, simply put, “software”) that it shall execute. For starting the NFRT execution, it initialises the software to a—possibly unique—genesis state. Beginning from this genesis state, an NFRT state evolution according to this embodiment follows a strict one-way continuity by using cryptographic hash functions on every state change. The so-formed continuous chain of state hashes can be reproduced and validated with the external input data that is stored during the NFRT execution: It consists of at least one NERT data block that includes information about the computer program (the application code), a genesis hash, a digitally signed final state hash as well as any external input data or state checks (see below). Long NFRT executions or multiple-stage software execution can be split up into multiple subsequent NFRT blocks that form a hash pointer based blockchain data structure. Each single NFRT block can be reproduced and validated independently.

The provable remote execution provided according to the cryptographic protocol (“NFRT protocol”) ensures that software, operated in untrusted client environments, is being executed in an authorized way without being tampered with. This particular exemplary embodiment is based on the recognition that it can be useful to increase information entropy with each change of software state to form a strong one-way continuity of the state evolution.

FIG. 1 shows a simplified schematic view of an exemplary information flow scheme that illustrates the NFRT state evolution. Starting from a genesis state (represented by a genesis hash 1), cryptographic hash functions are used upon every state change to compute a state hash 2 of the current software state, which can be a final state 3, an initial or “genesis” state 4 or an intermediary state 5. The state hash 2 of the final state 3 is the final state hash 6. The repeated and iterative application of a cryptographic hash function creates a “state evolution” 7 that is a continuous sequence (or “stream”) of hash values (the state hashes 2) until the final state 3 is reached, allowing for the computation of the final state hash 6. Each state hash 2 increases the information entropy of the system, which makes it practically infeasible to reverse the state evolution 7 from any given point, as well as to skip steps in the state evolution 7.

In addition to the information entropy achieved by the repeated application of a hash function, physical entropy may be introduced by input data 8 locally available at the network client and processed by the computer program during execution (at runtime), which can influence the state evolution 7 and consequently the final state 3 and final state hash 6.

Moreover, the state hashes 2 can be used as cryptographically secure pseudo-random numbers to seed application random-number generators (RNGs) used by the computer program. The immediate feedback of randomness achieved in this case gives the state evolution 7 an even stronger dependency on its preceding states. In applications where humans or the environment interact with the software by providing input data 8, the feedback of pseudorandom entropy to the state—and thus to the output—increases the introduction of physical entropy.

The NFRT protocol of this embodiment is executed in three consecutive steps, starting with an initialisation handshake when a network client requests an authorised NFRT execution from an authority, e.g. a trusted network server. Once the initialisation is finished and authorised by the authority, the protocol is being operated together with the execution of the respective computer program on the network client (e.g. the client device), to which the NFRT protocol is being applied. This may also include optional regular update handshakes (“state checks”) between the network client and the authority during runtime. In that case, a continuous connection between the network client and the authority is required. Those state checks can be conducted to avoid attacks based on client environment virtualisation (see below). After the runtime execution is finished, the protocol allows the authority (e.g. a network server different from the network client) to validate and prove the correctness, authenticity and integrity of the remote execution based on the NFRT data. The three subsequent steps of the NFRT protocol are described in more detail in the following.

As mentioned above, each authorised NFRT execution starts with a handshake to agree on a particular computer program and—possibly unique—initialisation parameters. The initialisation parameters are used to set the computer program into a genesis state. After the network client's request to start an NFRT execution is authorised, the initialisation can be provided by an authority's digital signature of some unique runtime information (for example, including a unique genesis seed) as well as of a hash of the computer program that will be executed by the network client. The signature may be used as genesis hash 1 for the state evolution 7, and thus defines together with the genesis state 4 of the computer program the first state hash 2. If the application uses RNG elements for initialisation or in the first state update, the genesis hash 1 may also be used as the genesis seed, i.e. an initial RNG seed. The initialisation signature from the authority is also used by the network client or the public to validate the legitimacy of the seed and the computer program, for example a particular executable application file.

FIG. 2 shows an overview of the data and information flow at the initialisation for an NFRT execution. Usage of an RSA signature scheme and a SHA3 hashing scheme would be suitable choices to implement the digital signature and the state hashes respectively. To authorise an NFRT execution, the authority—for example, a network server 9—digitally signs with its server private key 10 a block header 11 comprising unique information 12 about the given runtime execution as well as the program hash 13 of the authorised computer program. The resulting digital signature 14 will be validated 26 by the network client 15, and is also used for the genesis hash 1 and genesis seed 16. The network server 9 may optionally also provide the computer program 17 in the form of application code executable by the network client 15.

After the initialisation is finished, the network client 15 creates one or more data blocks 18 to store the NFRT data (also, “NFRT blocks”). Each block 18 includes a block header 19 comprising a block header hash 20, which is a cryptographic hash of the block header 11, 19 of the previous block, to form a hash pointer-based blockchain. An NFRT block 18 further comprises a log 21 of any external entropy sources, such as input data 8 or state checks, and the final state hash 6 resulting from the NFRT execution 22. The block header 19 may also comprise a copy of the unique runtime information 12 or other unique block information 23 as well as a digital signature 24 of the block header 19 generated by the network client 15 with a client private key 25. This digital signature 24 is available only when the block header 19 is complete, including the final state hash 6. By using the digital signature 24 as genesis seed 16 for subsequent NFRT blocks 18, the protocol can enforce that the execution of the computer program for generating the subsequent NFRT blocks 18 can only be started after the execution of the computer program for generating present NFRT block 18 is finished.

The computer program 17 does not have to be exchanged every time an NFRT execution 22 is performed, but comparing the program hash 13 to check whether the network client 15 will run an authorised version of the computer program 17 is useful and sufficient to avoid worthless executions of obsolete program versions. Otherwise, that is, in case of a hash mismatch, an update of the computer program should be conducted by receiving a new copy of the computer program with the network client 15. In the present example, an agreement on the computer program as well as the genesis seed 16 is required for an authority to eventually be able to validate the NFRT data during an (optional) asynchronous and potentially downstream validation.

After seeding the computer program state with the genesis hash 1 as described above, the NFRT execution 22 on the network client 15 can start. Every time the software state changes, e.g. due to an external input or processes in the software logic, the NERT protocol is followed. For example, this may happen or be triggered in every frame of a computer game (e.g. 60 times per second), or in case of a remote vending machine once every couple of weeks when it is used. Also, high frequency applications related to sensorics or automation systems can be operated within the present NFRT framework.

FIG. 3 schematically shows the data flow scheme of the NFRT protocol according to the present embodiment during operation and execution of the computer program 17. At every state update (“evolution step”), the protocol reads the software state and the previous state hash (in case of the initial state the genesis hash) and based on this information generates a new state hash 27. With ongoing runtime, this creates a seamless chain of state hashes 2, one for every state update (see FIG. 1). This hash chain can be interpreted as a continuous information entropic state evolution 7 starting from the genesis hash 1 and eventually reaching the final state hash 6.

Information entropy is being increased in every step by the hashing algorithm, and physical entropy can be brought into the system with external input data 8 (user inputs, communication with other devices, etc.). For anyone to be able to later validate the NFRT and reproduce the hash chain, all external inputs 8 are logged together with (at least) the final state hash 6. Logging also the full hash chain is optional and, if storage and transfer capacity allow for it, has the benefit of seeing exactly where problems (in terms of deviations from the original hash chain during validation) occur and thus could help with the identification of bugs or errors. It is, however, not required for the use of the NFRT technology.

The most recent intermediary state hash (or the genesis hash) can be used as RNG seed 28 for subsequent continuation of the NFRT execution to immediately introduce cryptographically secure pseudo-randomness back to the runtime execution. This process of entropy feedback prohibits the network client 15 from tampering by using pre-written input data 8 in, e.g., in gaming scenarios: Every software state would depend on the full history of states, which forces the player to always react to the unique and real-time software situation. As RNGs are based on pseudo-randomness and the hashing algorithm is deterministic as well, all the entropy and pseudo-randomness can be reproduced later in the validation process based on the input data 8 recorded in the log 21.

Some attack vectors to tamper with an NFRT execution are based on the creation of multiple copies of any state and let them evolve independently (e.g., by using AI systems or bots on virtual client machines to produce different input values). Each state evolution would be a legitimate one, as a continuous state hash chain would always be valid.

FIG. 4 illustrates the creation and evolution of two independent state evolutions 7a, 7b based on what can be called a “fork attack”. The network client 15 may use different input data 8a, 8b during execution of the computer program 17, for example to try different movements in a game and test, which movements achieve the higher game score. Consequently, based on the different input data 8a, 8b, also the game states will differ, including the final states 3a, 3b, as well es their respective state hashes 2a, 2b and final state hashes 6a, 6b. When both final states 3a, 3b are determined, the network client 15 could identify the final state 3a, 3b associated with the higher game score and generate a digital signature 24 only for the identified preferred final state. In particular in cases where the authorisation for NFRT execution granted by the network server 9 is tied to a participation fee (like in game tournaments), this fork attack would allow network clients to gain an unfair advantage (over other network clients and/or over the host). To limit the advantage of this attack, for example the network server 9, acting as authority in the present embodiment, can randomly send state checks 29 to the network client 15, including a randomly chosen “nonce” 30, which is a cryptographic nonce, i.e. an arbitrary number that can be used just once in a cryptographic communication (see FIG. 3). The network client 15 according to the NFRT protocol includes the nonce 30 into the next state hash 27. Information about in which state the nonce 30 is included is sent immediately to the network server 9 and recorded there for use during NFRT validation 31. If the network client 15 would not detect a random state check 29 within a given time frame, it could be assumed that the connection to the network server 9 has been lost or is throttled on purpose, and the NFRT protocol can enforce stopping the execution based on the missing random state checks 29. This form of random state checks also limits advantages of executing the computer program 17 in a virtual environment that runs slower or faster than real time—or making save states and using replays. All attacks based on virtualisation and multiplication of a software state are then limited to the time between two random state checks 29. The higher the requirements for integrity of an NFRT execution are, the shorter the average time between two random state checks 29 can be chosen.

The result of the NFRT execution 32 is an NFRT block 18 comprising the authorised genesis hash 20, 1 (which can be the hash of the block header of the preceding NFRT block), the final state hash 6, and the log 21 of the external input data 8 of the whole runtime (see FIG. 2). The NFRT block 18 contains a block header 19 which includes information to form a hash pointer based blockchain data structure. An NFRT block 18 or multiple NFRT blocks can be validated during NFRT validation 31. The NERT validation 31 can be performed by the network server 9 or by a different trusted authority and for example any participant of a public consensus network other than the network client 15 itself. To carry out the NFRT validation 31, the validating entity (in this example, the network server 9) receives the NFRT block 18 created by the network client 15, reproduces the hash stream of the state evolution 7 by executing the computer program 17 of the same initial parameters, input data and running state checks until it obtains a reproduced final state hash. If the reproduced final state hash matches the final state hash in the NFRT block 18, the network server 9 generates a block certificate 33 using the server private key 10. The block certificate 33 can be transmitted to the network client 15, which can use it as a proof of the correct NFRT execution and attach it to the NFRT block 18, thereby creating a validated NFRT 34.

FIG. 5 shows the data and information flow scheme of an NFRT validation 31. After at least one NFRT block 18 has been transmitted by the network client 15, it will be received to be (optionally) validated by the respective authority-which can be the public or, in this example, the trusted network server 9. The validator (e.g., the server/host, public, etc.) has access to the exact same computer program 17 which was executed during the NFRT execution by the network client 15. By using the genesis hash 20, 1 as well as the log 21 of the input data 8 and state checks 29 contained in the NFRT block 18, the network server 9 can reproduce the whole state evolution 7 by reproducing each state hash 35 of the state hash chain and recreating the RNG seed 28 based on the current reproduced state hash 35. If random state checks 29 were used, the network server 9 must also include those from the state check log 36 into the reproduction of the state evolution 7. The network server 9 then compares 37 the final state hash 6 of the NFRT block 18 with the reproduced final state hash 35 and validates the NFRT block 18 if the hash values match by generating a block signature 38 using the server private key 10. The NFRT block 18 combined with the block signature 38 form a block certificate 33. The network client 15 can receive the block certificate 33 from the network server 9, validate the block certificate 33 with the server public key 39 and assemble the validated NFRT 34 for further use or exchange.

If the NFRT consists of a series of multiple NERT blocks, they can be validated together and in parallel. The network client 15 receives the block certificate 33 for the last NFRT block, which confirms not only the correctness of that last NFRT block, but also of hash-linked previous unvalidated NFRT blocks. Hence, the network client 15 eventually controls a validated NFRT 34.

To further illustrate the present disclosure, another detailed embodiment is described with an exemplary execution and the generated data. This embodiment provides an example of a simple gaming application that can be securely operated and validated according to the NFRT protocol implementing the present method. This embodiment uses random state checks, and thus requires a continuous connection between the network client and the source of the state checks, e.g. a network server, which acts as authority, or any other (public) authority.

The protocol starts with an NFRT execution request from the network client to the network server as the relevant authority. This example requires that both the network client as well as the network server have access to the application code of the computer program that will be executed on the network client.

As mentioned above, the computer program in this embodiment implements a simple game, which is about catching falling objects 40 with a player-controlled platform 41 at the bottom of the screen 42. A new object appears with a probability of ⅓ at a random position in the top row 43 each frame and is randomly appointed the label “O” (increases score by 1) or “X” (decreases score by 1). The game state is updated once a second (1 fps), in which all falling objects 40 move downwards one row and the player can move the platform 41 to the left, the right, or not at all. The game is finished if the player reaches a score of 2 points (after starting at an initial score of 0 points). For the particular execution example discussed here, the game grid forming the screen 42 is of size 4 rows×4 columns with indexed rows and columns.

FIG. 6 shows an exemplary transition between two possible game states 44, 45. The first state 44 depicted on the left in FIG. 6 contains two “X” elements 46 and one “O” element 47, with the platform 41 in the leftmost column 48. During this frame, the user gives local input data at the network client to move the platform 41 one cell to the right. The movement happens in the next frame, which also moves all existing elements 40 down one row. A new “O” element 49 appears randomly in the leftmost column, while the “X” element 46 previously located in the rightmost column (4) disappears.

The example NFRT request has an expiration time of two minutes and includes random state checks with a frequency of less than 10 seconds. The created NFRT can only be validated by the network server, as state check data is not stored in the NFRT block, but only locally by the network server. If public validation would be required, the NFRT block would also include certified information of state checks (that is, a state check log), so that anyone can reproduce the state evolution with all external entropy sources.

Also, it is noteworthy, that this example only produces one single NFRT block for an entire game. If the client would request to have an NERT for two games in a row, the second game can be initialized with a hash including the header and the final state hash of the first NFRT block as new genesis hash. The client would create a new block header for the second block of a new NFRT data block chain, which can subsequently and independently be validated by the server or any public authority.

In the present example, the computer program may be identified by a hash value, e.g. generated by the SHA3-256 hash function. The digital signature of the NFRT data block may be an RSA-encrypted hash computed with the SHAKE256 hash function. Similarly, any state hash may be computed using the SHAKE256 hash function. The NFRT block may further comprise an expiration time stamp, which defines a latest time for successful validation. The computer program may be implemented such that it expects random state checks at least every ten seconds and stops execution if it waits for a new random state check longer than ten seconds.

The software state of the computer program, which together with the previous state hash forms the payload for the state hash in this example comprises the current position/column of the player, the complete game map including all elements (“X” and “O”) and their positions, the current score of the player, a nonce received with a latest random state check, and all user inputs together with a timestamp in “game time” (e.g. in the simplest case, a state counter, which counts the states the game went through previously).

The nonce generated by the network server can be a 32 bit random number combined with a timestamp representing the system clock (UNIX time in seconds) of the server system. After generation, this nonce is sent to the network client as part of the random state check. The server and/or the client can keep track of the generated and exchanged random state checks by storing the generated nonce together with a timestamp in game time and—optionally (for cross-checking)—with the latest state hash. The history of random state checks stored in this way is used during validation to reproduce the same nonces at the same time as during execution.

Any party, other network clients, service or trusted authorities, performing a validation of a NFRT block execute the computer program themselves and replay user inputs and random state checks from the data contained in the NFRT block as described above. If the validation arrives at the same final state hash that is included in the NFRT block, the validating entity may generate a validation certificate e.g. by encrypting the block header hash with their own private key using for example SHAKE256-RSA.

To further illustrate the above embodiment more in detail, a concrete execution of the example game is described with all involved parameters, data and input step by step. To properly calculate the hashes and random (RNG) values, initial conditions for a NERT execution as well as the RSA key pairs of both client and server are given. The network client sends an NFRT authorisation request for the given software with the ID “Example_Game_v0.8.0” on Feb. 22, 2022, at 22:35 GMT to the network server, with an expiration date two minutes after. The network server creates an NFRT block header, a hash of the block header, and the genesis seed, which is actually a digital signature formed by an encrypted version of the block header hash, according to the client's request.

```
RSA key pairs:
serverPrivateKey(base 64) = MIHCAgEAMA0GCSqG-
SIb3DQEBAQUABIGtMIGqAgEAAiEAgPLzsB+21N9xtRTs-
wSjt4qfz36DHzVailo0xrZJFT4kCAwEAAQIgNTuWzDubb6+6skWsI2WxJk1Zfn-
SYzH1J7rbLAISYwoECEQDB330ZqLjzqgeS9PczIWXRAhEAqkVg49rC/euHbe-
MOFxBkOQIQFBkhFOni0o/L3TY78jcCIQIRAJ0nO64SEzbZVD4P+sk+z8ECEEv-
zelEJEeN5tQVULnhdTRo=
serverPublicKey(base 64) = MDwwDQYJKoZIhvcNAQEBBQAD-
KwAwKAIhAIDy87AfttTfcbUU7MEo7eKn89+gx81WopaNMa2SRU+JAgMBAAE=
clientPrivateKey(base 64) = MIHCAgEAMA0GCSqG-
SIb3DQEBAQUABIGtMIGqAgE-
AAiEApxNWrdqS/JQfTrzdj3t87CRZvgNLT1e4Vy8GCIbuz68CAwE-
AAQIgNtvrtzQw1UyRpxnuqiFDGALVZ7ZnIMf6ngDZQkkHbhkCEQDSgghMpwGgT2
F+pZQyIF/VAhEAyy587xSdq9qSN5Oz6hk3cwIQN4/exOynvzp0j0sA7KIi6QI-
RAI889MKvrABNlKstq7arlFUCEFnJthKLvpeZ4VYWNZRe3W4=
clientPublicKey(base 64) = MDwwDQYJKoZIhvcNAQEBBQAD-
KwAwKAIhAKcTVq3akvyUH0683Y97fOwkWb4DS09XuFcvBgiG7s+vAgMBAAE=
Initialization data:
NFRT_blockHeader = {
  “softwareID”: “Example_Game_v0.8”,
  “codeHash” =
“9a0920968e016b09aec214b94678570698c5a1a890eb877bf59dd0a78ca58b
d4”,
  “runtimeID”: “1337”,
  “blockNumber”: “1”,
  “expirationDate”: “1645569420”
}
headerHash = 4321d51e39837c4b
genesisSeed(hex) =
5758e57eab5761225c8976e04cc94865177deac1e2eb9bb1db6a8c9b1ad330f
2
```

After the block header and the genesis seed are transmitted to the network client, the network client will decode the genesis seed with the server's public key and checks if the code hashes as well as the header hashes match. After authentication is completed, the network client starts the NFRT execution using the genesis seed to create the initial state. The state hashes are produced by providing the given information to the hashing algorithm as a string, e.g. in the case of the initial state hash

stateHash = SHAKE256[64 bit hex output]...
...(“[5758e57eab5761225c8976e04cc94865177deac1e2eb9bb1db6a8c9b1ad33
0f2,1,[0,0,0,0;0,0,0,0;0,0,0,0;0,0,0,0],0,0]”) = 309a90f213e5cf7e

or the state hash of state S5

stateHash = SHAKE256[64 bit hex output]...
...(“[aebbe9660eb27d4,2,[0,0,−1,0;0,0,0,0;0,1,0,0;0,0,0,0],1,...
...[8313c95e,1645569307]]”) = cae8a6460b6ecb4a

The following table provides a detailed view of the state evolution of the runtime from the initial state so to the final state S6, where the user reaches the defined winning game score of 2. The user inputs (in states S2, S3, and S5) as well as the state check from the server (state S2) provide external entropy whenever they occur. The variable “objectMatrix” holds the current game map. The displayed state is a graphical representation of the content of the variables “objectMatrix” and “playerColumn” as it is seen by the player during the game.

| Variable Name | State S0 (init) | State S1 |
|---|---|---|
| stateCounter | 0 | 1 |
| objectMatrix | [0, 0, 0, 0; | [1, 0, 0, 0; |
| | 0, 0, 0, 0; | 0, 0, 0, 0; |
| | 0, 0, 0, 0; | 0, 0, 0, 0; |
| | 0, 0, 0, 0] | 0, 0, 0, 0] |
| userInput | | |
| playerColumn | 1 | 1 |
| gameScore | 0 | 0 |
| checkNonce | 0 | 0 |
| stateHash | 309a90f213e5cf7e | 65124b0067dfaa50 |
| NFRT_block. | [ ] | [ ] |
| inputArray | | |
| Displayed State | 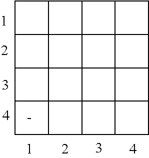 [SMILES: C1C2C3C4CC5C6C7CC8C9C%10CC%11C%12C1C21C32C45C63C78C94C%11%10C%121C234] | 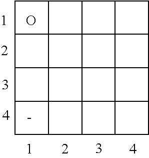 |
| Variable Name | State S2 | State S3 |
| stateCounter | 2 | 3 |
| objectMatrix | [0, 0, 0, 0; | [0, 1, 0, 0; |
| | 1, 0, 0, 0; | 0, 0, 0, 0; |
| | 0, 0, 0, 0; | 1, 0, 0, 0; |
| | 0, 0, 0, 0] | 0, 0, 0, 0] |
| userInput | “right” | “left” |
| playerColumn | 2 | 1 |
| gameScore | 0 | 0 |
| checkNonce | [8313c95e, 1645569307] | [8313c95e, 1645569307] |
| stateHash | 6b54e908bc66d66c | 4f0f31b9df719500 |
| NFRT_block. | [2, “right”] | [2, “right”; |
| inputArray | | 3, “left”] |
| Displayed State | 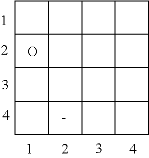 | 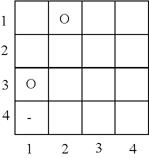 |
| Variable Name | State S4 | State S5 |
| stateCounter | 4 | 5 |
| objectMatrix | [0, 0, 0, 0; | [0, 0, −1, 0; |
| | 0, 1, 0, 0; | 0, 0, 0, 0; |
| | 0, 0, 0, 0; | 0, 1, 0, 0; |
| | 1, 0, 0, 0] | 0, 0, 0, 0] |
| userInput | | “right” |
| playerColumn | 1 | 2 |
| gameScore | 1 | 1 |
| checkNonce | [8313c95e, 1645569307] | [8313c95e, 1645569307] |
| stateHash | aebbe9660eb2f7d4 | cae8a6460b6ecb4a |
| NFRT_block. | [2, “right”; | [2, “right”; |
| inputArray | 3, “left”] | 3, “left”; |
| | | 5, “right”] |
| Displayed State | 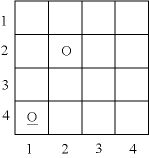 | 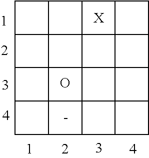 |

| Variable Name | State S6 (final) |
|---|---|
| stateCounter | 6 |
| objectMatrix | [0, 0, 0, 0; |
| | 0, 0, −1, 0; |
| | 0, 0, 0, 0; |
| | 0, 1, 0, 0] |
| userInput | |
| playerColumn | 2 |
| gameScore | 2 |
| checkNonce | [8313c95e, 1645569307] |
| stateHash | d15c3138c655460a |
| NFRT_block. | [2, “right”; |
| inputArray | 3, “left”; |
| | 5, “right”] |
| Displayed State | 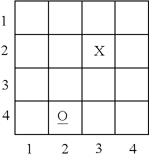 |

After the game score reaches 2 points, the network client updates and compiles the NFRT block to the following value, digitally signs it with its private key, and sends it for validation to the network server.

```
NFRT_block = {
  “NFRT_blockHeader”: {
    “softwareID” : “Example_Game_v0.8”,
    “codeHash” =
“9a0920968e016b09aec214b94678570698c5a1a890eb877bf59dd0a78ca58bd4”,
    “runtimeID”: “1337”,
    “blockNumber”: “1”,
    “expirationDate”: “1645569420”
  },
  “genesisSeed”:
“5758e57eab5761225c8976e04cc94865177deac1e2eb9bb1db6a8c9b1ad330f2”,
  “inputArray”: “[2, “right”;
      3, “left”;
      5,“right”]”,
  “finalStateHash”: “d15c3138c655460a”
}
blockHash = 8d4671800853134b
clientSignature(base 64) = Y+M+zbNGvSBfYY4Gi/q+ba+FrwannWNXipx1AiWx-
coY=
```

If the final state hash of the NFRT block is identical with the final state hash of the reproduced state evolution on the server side, the network server would sign a certificate on the NERT block to send to the client, using a SHAKE256-RSA scheme:

NFRT_hash = SHAKE-256[64 bit hash output]...
...([NFRT_block,clientSignature(base 64)]) = feea4cac755c78a9
validationCertificate(base 64) = ...
... RSA_encrypt(NFRT_hash,serverPrivateKey) = ...
... dgMs5f+TXTeijcYwWf9GrQ/8KAZ7xII1CXmnChsJRN8=

The present disclosure extends to a network client executing the client-side game code and protocol as described above and showing the displayed state to the player on a computer screen as well as accepting inputs from the user, e.g. via a keyboard, computer mouse, touchpad or touchscreen. Moreover, the present disclosure further extends to a system comprising such a network client as well as a network server executing the server-side protocol as described above and performing on-demand validation.

The activity diagram in FIG. 7 diagrammatically illustrates a more generalized version of the game application of the previous embodiment by showing an exemplary activity flow and data flow.

To further illustrate the present disclosure, the following pseudo code shows an exemplary implementation of an NFRT protocol as described above. This example comprises three code blocks, two of them are executed by the network client and e.g., operated on a client machine (“CLIENT” and “CLIENT RUNTIME”), and one is executed by a network server and e.g., operated on a server machine (“SERVER”). The server code is actively listening to an authorization request from the client, which the client sends when running the “CLIENT-HANDSHAKE” code block. This includes the initialization handshake and provides the required seed data for the NERT game execution.

```
              CLIENT
SEQUENCE getNFRTAuthorization( )
  SET softwareID = “Example_Game_v0.8”
  COMPUTE clientCodeHash = SHA3-256 hash of code block “CLIENT_RUNTIME”
  SEND softwareID to SERVER #as authorization request
  LISTEN to receive NFRT_blockHeader and genesisSeed from SERVER
  COMPUTE headerHash = SHAKE256[64 bit hash output] (NFRT_blockHeader)
  COMPUTE checkHeaderHash = RSA_decrypt(genesisSeed, serverPublickey)
  IF NFRT_blockHeader.codeHash EQUALS clientCodeHash AND ...
  ... checkHeaderHash EQUALS headerHash AND ...
  ... NFRT_blockHeader.expirationDate IS GREATER THAN current time
    RUN NFRT_game(NFRT_blockHeader, genesisSeed) #execution of ...
  ... code block “CLIENT_RUNTIME”
  ELSE
    STOP SEQUENCE #NFRT not valid
  END IF
END SEQUENCE
SEQUENCE getNFRTValidation( )
  COMPUTE blockHash = SHAKE256[64 bit hash output] (NFRT_block)
  COMPUTE clientSignature = RSA_encrypt(blockHash, clientPrivateKey)
  SEND [NFRT_block, clientSignature] to SERVER
  LISTEN to receive validationCertificate from SERVER
  SAVE [NFRT_block, validationCertificate]
END SEQUENCE
            CLIENT_RUNTIME
START PROGRAM NFRT_game(INPUT NFRT_blockHeader, genesisSeed)
  SEQUENCE initializeGameState( )
    INIT gameScore = 0
    INIT objectMatrix = 4 x 4 matrix of zeros
    INIT internalRngSeed = 0
    INIT checkNonce = 0
    INIT stateCounter = 0
    INIT stateCounter_lastStateCheck = 0
    SET updateInterval = 1 second
    SET rngSeed = genesisSeed
    CALL getRandomNumber([1 to 4], rngSeed) RETURNING playerColumn
    COMPUTE stateHash = SHAKE-256[64 bit hash output] (genesisSeed + ...
      ... playerColumn + objectMatrix + gameScore + checkNonce)
    SEND initStateHash = stateHash to SERVER
    INIT NFRT_block = {
      “blockHeader”: NFRT_blockHeader,
      “genesisSeed”: genesisSeed,
      “inputArray”: [ ],
      “finalStateHash”: [ ],
      “clientSignature”: [ ]
    }
    DISPLAY gameGrid = 4 x 4 grid
    DISPLAY playerObject in gameGrid[row 4, playerColumn]
  END SEQUENCE
  REPEAT gameLoop( ) once every updateInterval
    INCREMENT stateCounter
    SET rngSeed = stateHash
    SEQUENCE updateObjectMatrix( )
      COMPUTE circular shift of objectMatrix rows downwards once
      SET objectMatrix[row 1, all columns] to zero
      CALL getNewObject(rngSeed) ...
      ... RETURNING newObject = [newObjectColumn, newObjectValue]
      SET objectMatrix[row 1, newObjectColumn] to newObjectValue
    END SEQUENCE
    GET userInput
    IF userInput EQUALS “left” AND playerColumn > 1
      DECREMENT playerColumn
    ELSE IF userInput EQUALS “right” AND playerColumn < 4
      INCREMENT playerColumn
    ELSE do nothing
    END IF
    ADD objectMatrix[row 4, playerColumn] to gameScore
    SEQUENCE updateNFRT_block ( )
      LISTEN to receive stateCheck from SERVER
        IF (stateCounter − stateCounter_lastStateCheck) > 10
          DISPLAY “connection to SERVER lost”
          STOP PROGRAM #NFRT not valid
        END IF
      IF receive stateCheck
        SET stateCounter_lastStateCheck = stateCounter
        SET checkNonce = stateCheck
        SEND [stateCounter, stateHash] to SERVER
      END IF
      COMPUTE stateHash = SHAKE-256[64 bit hash output] (stateHash + ...
      ... playerColumn + objectMatrix + gameScore + checkNonce)
      IF userInput EQUALS “left” OR “right”
        APPEND [stateCounter, userInput] to NFRT_block.inputArray
      END IF
    END SEQUENCE
    DISPLAY playerObject in gameGrid[row 4, playerColumn]
    DISPLAY objectMatrix values in gameGrid with −1 as “X” and 1 as “O”
  UNTIL gameScore = 2
  SET NFRT_block.finalStateHash = stateHash
  FUNCTION getNewObject(INPUT seed)
    CALL getRandomNumber((0 to 1), seed) RETURNING randomNumber
    IF randomNumber((0 to 1), seed) < 1/3
      COMPUTE newObjectColumn = getRandomNumber([1 to 4], internalRngSeed)
      COMPUTE newObjectValue = round(getRandomNumber((0 to 1), ...
      ... internalRngSeed))
      IF newObjectValue EQUALS 0
        SET newObjectValue = −1
      END IF
      RETURN newObject = [newObjectColumn, newObjectValue]
    ELSE
      RETURN newObject = [1,0]
    END IF
  END FUNCTION
  FUNCTION getRandomNumber(INPUT range, seed)
    COMPUTE nextRandomNumber = (65539 x seed) mod 2\hat{ }31 #RANDU algorithm
    SET internalRngSeed = nextRandomNumber #set as global variable
    COMPUTE normRandomNumber = nextRandomNumber/2\hat{ }31 #interval (0,1)
    IF range EQUALS (0 to 1)
      RETURN normRandomNumber
    ELSE IF range EQUALS [1 to 4]
      RETURN outputRandomNumber = ceiling function of (normRandomNumber * 4)
    ELSE
      RETURN error
    END IF
  END FUNCTION
END PROGRAM
```

```
            SERVER
START PROGRAM NFRT_server( )
  SEQUENCE provideNFRTAuthorization( )
    LISTEN to receive softwareID from CLIENT
    COMPUTE codeHash = SHA3-256 hash of code block “CLIENT_RUNTIME”
    SET NFRT_blockHeader = {
      “softwareID”: softwareID,
      “codeHash”: codeHash,
      “runtimeID”: create unique runtime ID,
      “blockNumber”: 1,
      “expirationDate”: current time + 2 minutes
    }
    COMPUTE headerHash = SHAKE256[64 bit hash output] (NFRT_blockHeader)
    COMPUTE genesisSeed = RSA_encrypt(headerHash, serverPrivateKey)
    SEND NFRT_blockHeader and genesisSeed to CLIENT
    LISTEN to receive initStateHash from CLIENT_RUNTIME
      IF initStateHash IS NOT received before expirationDate
        STOP PROGRAM #NFRT not valid
      END IF
    SET NFRT_validationData = {
      “blockHeader”: NFRT_blockHeader,
      “initStateHash”: initStateHash,
      “stateCheckData”: [ ]
    }
  END SEQUENCE
  REPEAT stateCheckLoop( )
    LISTEN to receive [NFRT_block, clientSignature] from CLIENT
      WAIT for random time < 10 seconds
      COMPUTE checkNonce = [32 bit random number, currentTime] #unix time
      SEND stateCheck = checkNonce to CLIENT RUNTIME
      LISTEN to receive [stateCounter, stateHash] from CLIENT RUNTIME
        IF [stateCounter, stateHash] ARE NOT received in < 2 seconds
          STOP PROGRAM #NFRT not valid
        END IF
      APPEND [stateCounter, stateHash, checkNonce] to ...
      ... NFRT_validationData.stateCheckData
  UNTIL receive [NFRT_block, clientSignature] from CLIENT
  SEQUENCE NFRT_validation( )
    COMPUTE blockHash = SHAKE256[64 bit hash output] (NFRT_block)
    IF blockHash EQUALS RSA_decrypt(clientSignature, clientPublicKey)
      RUN NFRT_game (NFRT_blockHeader, genesisSeed) #code block ...
      ... “CLIENT_RUNTIME”
        SKIP all “DISPLAY” actions
        SET updateInterval = 0 #re-execute as fast as possible
        USE NFRT_block.inputArray as userInput
        USE NFRT_validationData.stateCheckData as stateCheck
      IF stateHash EQUALS NFRT_block.finalStateHash
        COMPUTE NFRT_hash = SHAKE256[64 bit hash output] (NFRT_block + ...
        ... clientSignature)
        COMPUTE validationCertificate = RSA_encrypt (NFRT_hash, ...
        ... serverPrivateKey)
        SEND validationCertificate to CLIENT
      ELSE send error message to CLIENT
      END IF
    ELSE send error message to CLIENT
    END IF
  END SEQUENCE
END PROGRAM
```

1. Method for provable remote execution of a computer program by a network client having a client private key, the method comprising the steps of:
receiving by the network client a copy of the computer program,
executing by the network client the computer program,
generating by the network client a digital signature of at least a final state of the computer program with the client private key,
transmitting by the network client the digital signature of the final state for validation of the execution of the computer program.

2. Method according to claim 1, characterised in that executing the computer program comprises the step of determining by the network client a state hash of at least one intermediary state of the computer program, wherein the digital signature generated by the network client is based on the final state and at least one state hash of an intermediary state.

3. Method according to claim 2, characterised by determining by the network client state hashes of the at least two sequential intermediary states of the computer program, wherein the second state hash and every later state hash is computed from at least the corresponding intermediary state and the previous state hash.

4. Method according to claim 3, characterised in that the method comprises:
receiving by the network client a genesis hash,
determining by the network client the first state hash from at least the corresponding intermediary state and the received genesis hash.

5. Method according to claim 1, characterised in that the copy of the computer program received by the network client is digitally signed and the method comprising the steps of:
before executing the computer program, verifying by the network client that the digital signature of the computer program is by a trusted authority.

6. Method according to claim 1, characterised in that the computer program is configured to receive input data locally available at the network client during executing the computer program, wherein the network client records the input data received and provides the recorded input data together with the digital signature.

7. Method according to claim 6, characterised in that the network client receives input data affecting the final state from a network during executing the computer program.

8. Method according to claim 7, characterised in that the network client expects to receive input data affecting the final state from the network at one or more instances during executing the computer program, wherein said one or more instances are predefined or defined by the computer program.

9. Method according to claim 8, characterised in that the expected input data is unpredictable during each execution of the computer program.

10. Method according to claim 1, characterised in that the computer program uses randomly generated data, wherein the randomly generated data is generated locally by the network client.

11. Method according to claim 10, characterised in that the method comprises:
receiving by the network client a genesis seed,
generating by the network client the randomly generated data based on the received genesis seed.

12. Method according to claim 11, characterised in that the method comprises:
generating by a network server a genesis seed based on the computer program, a current time stamp and/or a server private key,
transmitting the generated genesis seed from the network server to the network client.

13. (canceled)

14. (canceled)

15. Network client for provable remote execution of a computer program, the network client having a client private key, the network client configured to:
receive a copy of the computer program;
execute the computer program;
generate a digital signature of at least a final state of the computer program with the client private key; and
transmit the digital signature of the final state for validation of the execution of the computer program.

16. System for provable remote execution of a computer program comprising a network client having a client private key, the network client configured to:
receive a copy of the computer program,
execute the computer program,
generate a digital signature of at least a final state of the computer program with the client private key, and
transmit the digital signature of the final state for validation of the execution of the computer program,
wherein the computer program uses randomly generated data, wherein the randomly generated data is (i) generated locally by the network client by receiving a genesis seed and generating the randomly generated data based on the received genesis seed or (ii) received from a network server that generates a genesis seed based on one or more of the computer program, a current time stamp or a server private key.
